(19) United States
(12) Patent Application Publication
(10) Pub. No.: US 2003/0189897 A1
(43) Pub. Date: Oct. 9, 2003

(54) Dual line monitoring of 1‘protection with auto-switch

(75) Inventors: David E. Einstein, Morganville, NJ (US); Yung-Ching Sha, Edison, NJ (US)

Correspondence Address: MOSER, PATTERSON & SHERIDAN L.L.P., 595 SHREWSBURY AVE, FIRST FLOOR, SHREWSBURY, NJ, 07702, US

(73) Assignee: LUCENT TECHNOLOGIES INC.

(21) Appl. No.: 10/119,225

(22) Filed: Apr. 9, 2002

(51) Int. Cl. H04J 1/16

(52) U.S. Cl. 370/220

(57) ABSTRACT

A method and apparatus implementing a “1+1” protection scheme using two interface cards (transmitter and receiver) having a mathematically provable uptime rate.

### TECHNICAL FIELD

The invention relates to the field of communications systems and, more specifically, to a protective switching method and apparatus having a predictable average system uptime rate.

### BACKGROUND OF THE INVENTION

In a communications system requiring a very high uptime rate, a commonly used topography comprises redundant communications links (e.g., two physically distinct optical transmission links) to provide, thereby, a service line and a protection line. In the event of a cut or other damage that disrupts data traffic through the service line, the same data traffic may be retrieved from the protection line. In this manner, customer traffic is not interrupted.

The physical implementation of such a “1+1” protection system traditionally comprises a transmitter-side power splitter for directing common data traffic (i.e., customer traffic) to two interface cards, where one interface card provides its traffic to the service line and the other interface card provides its traffic to the protection line. A second pair of interface cards at the receiving side retrieves the common data traffic from the two lines and provides the retrieved traffic to respective inputs of a switch. The switch selects traffic from one of the interface cards (e.g., the service line card) and provides the selected traffic to an output terminal. It is noted that an interface card adapts various parameters of data traffic to convert data traffic between customer traffic and transmission traffic formats.

The four card “1+1” protection system works very well, though it is quite expensive since interface cards are very costly. However, such systems are typically necessary since they can be shown to exhibit an average system uptime above a level deemed necessary by, for example, local exchange carriers (LECs), and long distance carriers and other telecom service providers requiring a minimum quality of service (QoS) level. Absent an ability to prove adequate uptime rates, a service provider is unable to provide QoS guarantees to its customers.

### SUMMARY OF THE INVENTION

The invention comprises a method and apparatus implementing a “1+1” protection scheme using two interface cards (transmit and receive) that has mathematically provable uptime rate very close to the uptime rate of a traditional four-card solution. Advantageously, the invention may be implemented by modifying service provider software while using existing hardware.

Apparatus according to an embodiment of the invention comprises a switch for providing received data traffic from one of a service line and a protection line to an interface device; and a controller, for causing the switch to alternately select the service and protection lines according to a time period selected to provide a minimum system uptime rate. The time period and system uptime rate may be calculated according to various equations and method discussed in the disclosure.

### BRIEF DESCRIPTION OF THE DRAWINGS

The teachings of the present invention can be readily understood by considering the following detailed description in conjunction with the accompanying drawing in which:

FIG. 1 depicts a high-level block diagram of a communications system utilizing the teachings of the present invention;

FIG. 2 depicts a high-level block diagram of a controller suitable for use in the communications system of FIG. 1;

FIG. 3 depicts a flow diagram of a method according to an embodiment of the invention; and

FIG. 4 depicts a high level block diagram of a portion of the communications system of FIG. 1 modified according to an alternate embodiment of the invention;

To facilitate understanding, identical reference numerals have been used, where possible, to designate identical elements that are common to the figures.

### DETAILED DESCRIPTION OF THE INVENTION

The invention will be described within the context of a controlled switching device in which common data received via either a service line and a corresponding protection line (i.e., service and protection data communications paths) is periodically selected to produce a system having a predictable average system uptime rate. While several embodiments will be disclosed and described in more detail herein, it will be appreciated by those skilled in the art and informed by the teachings of the present invention that any system utilizing multiple data paths to carry common voice or data traffic and requiring a predictable high uptime rate may advantageously employ the present invention.

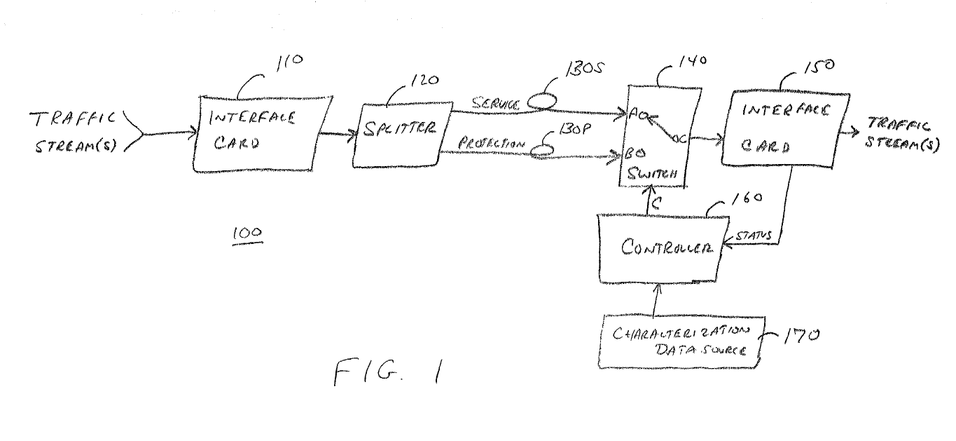

FIG. 1 depicts a high-level block diagram of a communications system utilizing the teachings of the present invention. Specifically, the communications system 100 of FIG. 1 receives at least one stream of data traffic (e.g., customer traffic) at a transmitter-side interface card 110. Transmitter-side interface card 110 processes the traffic stream(s) according to, for example, the respective customer and transmission traffic format requirements, and provides the resulting traffic stream(s) to a power splitter 120. The power splitter 120 splits and traffic stream(s) into two streams carrying substantially identical data traffic. Each of the two substantially identical data streams is carried by a respective medium such as an optical fiber medium, satellite link, free-air transmission medium and the like. More particularly, a service line 130S conveys the first substantially identical data streams to a first input of a switch 140. A protection line 130P conveys the second substantially identical data stream to a second input of the switch 140.

The switch 140, in response to a control signal C provided by a controller 160, selects or otherwise couples one of the received data streams to an output terminal. An interface card 150 coupled to the output terminal of switch 140 receives the selected data stream and converts the selected transmission format data stream into an appropriate customer format traffic stream(s). The selected one of the service line and the protection line is denoted as the “active” line, while the non-selected line is denoted as the “non-active” line.

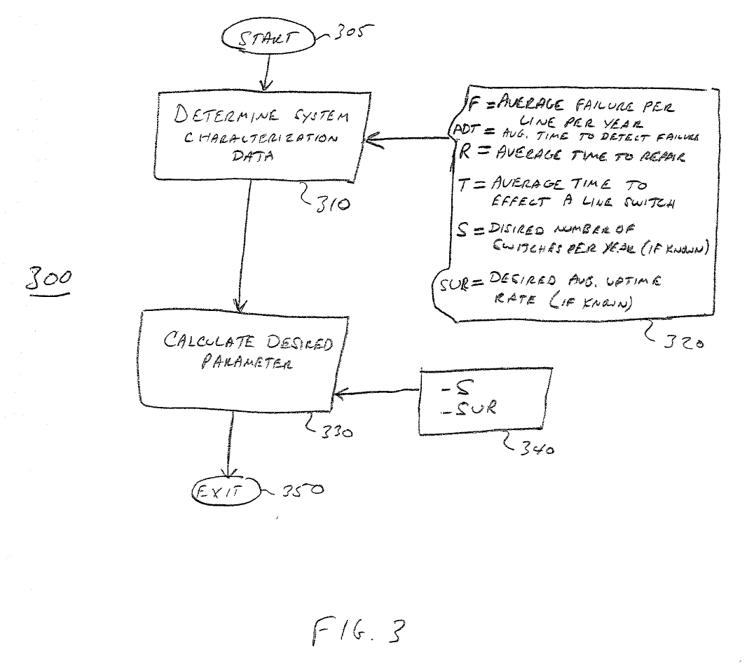

The second interface card 150 also provides status information STATUS to the controller 160. The controller 160 processes the received status information along with other information to determine operational states and other parameters associated with the transmission lines. One method for processing this information will be discussed in more detail below with respect to FIG. 3.

The invention advantageously utilizes only one interface card at each of the transmission side and receive side of a 1+1 data transmission system. While reducing the number (and subsequent cost) of the data transmission system, the use of a single receive side interface card means that full line status monitoring may only be performed on the presently selected transmission line (i.e., the service line or protection line). The line status of the non-selected line is not monitored simultaneously with the selected line. This is a limitation because the system operator has no alarm when the stand-by line fails. In this case, a non-selected line failure cannot be repaired in time and, if not in good repair, it cannot provide protection if the active line also fails.

The above problem is addressed by an alternate embodiment of the invention in an optical power monitor is added to one or both of the lines. However, since the optical power monitor can only detect loss of signal (LOS), it cannot detect loss of frame (LOF), alarm indication signal (AIS), signal degrade (SD) and other failures. The second technique is to provide an off-line interface card to monitor a group of stand-by lines. The second technique is cost effective if there are many stand-by lines in a group.

In various alternate embodiments of the invention, the controller 160 may receive and process output signals produced by the optical power monitor(s) and/or off-line interface card to assist in determining the existence and location of a fault. For example, a sudden drop in optical power provides a fairly clear and quick indication that a fault exists, such that the controller may respond immediately with a polling or query operation of the various intermediate network elements forming the communication path. In this manner, a network fault may be quickly identified and localized. Similarly, data provided by an off-line interface card may indicate which of a plurality of protection lines is ill-suited to such application due to faulty operation of the protection line. The controller may responsively cause the selection of this protection line to be avoided and, further, may indicate that the protection line must be repaired. The controller may also examine or query the various intermediate network elements forming the protection line to identify and localize any faults. Thus, the alarm and status measuring of the off-line interface card allows active examination of multiple redundant protection lines within a communications system.

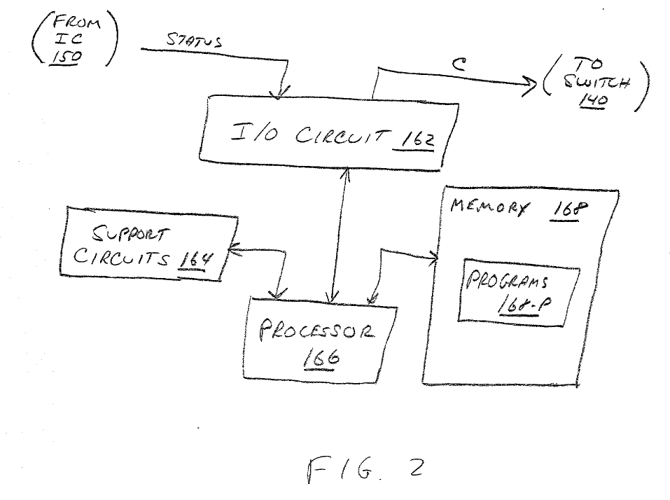

FIG. 2 depicts a high-level block diagram of a controller suitable for use in the communications system of FIG. 1. Specifically, the exemplary controller 160 of FIG. 2 comprises a processor 166 as well as memory 168 for storing various control programs 168-P. The processor 166 cooperates with conventional support circuitry 164 such as power supplies, clock circuits, cache memory and the like as well as circuits that assist in executing the software routines stored in the memory 168. As such, it is contemplated that some of the process steps discussed herein as software processes may be implemented within hardware, for example, as circuitry that cooperates with the processor 166 to perform various steps. The controller 160 also contains input/output (I/O) circuitry 162 that forms an interface between the various functional elements communicating with the controller 160. For example, in the embodiment of FIG. 1, the controller 160 communicates with the 2×1 switch 140 via a control signal C and with the second interface card 150 via a status signal STATUS.

Although the controller 160 of FIG. 2 is depicted as a general purpose computer that is programmed to perform at various control functions in accordance with the present invention, the invention can be implemented in hardware as, for example, an application specific integrated circuit (ASIC). As such, the process step described herein are intended to be broadly interpreted as being equivalently performed by software, hardware or a combination thereof.

FIG. 3 depicts a flow diagram of a method according to an embodiment of the invention. Specifically, the method 300 of FIG. 3 is entered at step 305 and proceeds to step 310, where a determination of system characterization data is made. As noted with respect to box 320, the determination at step 310 may include various conditions and/or parameters such as the average failure per line per year (F), the average time to detect a failure (ADT), the average time to repair the detected failure (R), the average time to effect a line switch (T), the desired number of switches per year (S) and/or the desired average system uptime rate (SUR).

At step 330, the desired parameter is calculated. That is, referring to box 340, at step 330 one of the desired number of switches per year (S) and the desired average system uptime rate (SUR) are calculated. The method 300 exits at step 350.

The above-described method 300 of FIG. 3 utilizes algorithms and equations such as discussed below with respect to equations 1 through 8. It will be appreciated by those skilled in the art informed by the teachings of the present invention that various sets of preconditions may be posited to enable the mathematical proof of a minimal system uptime rate, a desired system uptime rate, a desired maximum number of auto switches to provide a specified uptime rate and other permutations. These and other adaptations of the invention are contemplated by the inventor.

Referring now to FIG. 1, the controller 160 normally causes the switch 140 to select a different transmission line traffic stream at the expiration of a predetermined time interval (e.g., once or twice a day). The interface card 150 monitors the “health” of the presently selected transmission line traffic stream. If the interface card 150 determines that a problem exists with the presently selected transmission line traffic stream, then such information is conveyed to the controller 160 via the status line STATUS. In response, the controller 160 causes the switch 140 to select the other transmission line traffic stream. In this manner, the status of both the service and protection lines can be periodically monitored.

In one embodiment of the invention, several system preconditions and feature actions are provided, as follows:

System conditions:

(1) Auto-switch is implemented only in a two-card 1+1 protection solution;

(2) Auto-switch is stopped if there is a signal condition(s) such as signal failure (SF) or signal degrade (SD) in transmission line(s); and

(3) Auto-switch is stopped if there is an APS command such as manual switch or forced switch in process.

Feature actions:

(1) Each end switches from one line to the other line every a period of time;

(2) The stand-by line status is recorded in system memory;

(3) The software makes protection switch decision based on the current active line status and the stand-by line status in record;

(4) System operator can enable or disable auto-switch; and

(5) System operator can set the period of time to do auto-switch if it is enabled.

The operation of a system according to the invention will now be described within the context of a “auto switch” functionality, in which a receiver-side interface card automatically switches between a service line and a protection line. By switching more frequently between the service and protection lines, the interface card is able to monitor various performance metrics associated with the service and protection lines more frequently. Thus, from a line monitoring point of view, it is preferable to have the auto-switch shall do a switch as more often as possible. However, by switching more frequently there is more perturbation of data transmitted through the lines due to the amount of time necessary to effect a switch between the lines. Even through the traffic interrupt time may be quite short, often service metrics (such as error seconds) make this switch less attractive. So, from customer traffic's point of view, auto-switch shall do a switch as less often as possible. Based on the target system uptime rate, a balanced point may be figured out in the following sections.

Advantageously, the auto switch technique of the invention incurs no additional hardware cost and may be built on top of existing hardware. In this embodiment, the auto switch techniques are implemented by modifying software used to control the existing hardware. The modified software is used to determine, for example, how often a switch between the service line and protection line shall occur to provide a desired uptime rate or other parameter goal.

To prove that the system uptime rate provided by the topology of the present invention is appropriate to high quality carriers (i.e., those demanding a “five-nine” or 99.999% or better uptime rate), the inventor has determined the following methods. Using the below method, the topology of the present invention may be utilized in an environment in which a guaranteed uptime rate is required.

Specifically, in a system such as described above with respect to FIG. 1, the following conditions and relationships are provided in an embodiment adapted to determine a system uptime rate (SUR):

F: The average number of signal conditions per line in a year.

R: The average repair time of a line signal condition once it is detected.

S: The number of auto-switch operations occurring in a year.

T: The average switch time of an auto-switch operation.

The average detection time (ADT) for each line signal condition is given by equation 1, as follows:

ADT=(Total time in a year)/(2*S) (eq. 1)

The average un-available time (AUT) for each line signal condition is given by equation 2, as follows:

AUT=(Total time in a year)/(2*S)+R (eq. 2)

The average un-available time of one line in a year is given by equation 3, as follows:

$$= [ ( Total time in a year ) / ( 2 * S ) + R ] * F \\ = [ ( Total time in a year ) * F ] / ( 2 * S ) + R * F \qquad ( eq . 3 )$$

The number of events that both lines have signal condition at same time is given by equation 4, as follows:

$$= \{ [ ( Total time in a year ) * F ] / ( 2 * S ) + R * F \} * [ F / ( total time in a year ) ] \\ = ( F * F ) / ( 2 * S ) + ( F * R * F ) / ( total time in a year ) \\ \qquad ( eq . 4 )$$

The system average un-available time in a year is given by equation 5, as follows:

$$= [ ( F * F ) / ( 2 * S ) + ( F * R * F ) / ( total time in a year ) ] * R + S * T \\ = \frac{F * R * F}{2 * S} + \frac{F * R * F * R}{( total\_time \_in \_a \_year )} + S * T \qquad ( eq . 5 )$$

The average system uptime rate (SUR) is given by equation 6, as follows:

$$\begin{matrix}SUR = 1 - ( un \text{-} available time ) / ( total time in a year ) \\ = 1 - [ ( F * R * F ) / ( 2 * S ) + ( F * R * F * R ) / ( total time in a year ) + S * T ] / ( total time in a year ) \\ = 1 - \frac{F * R * F}{2 * S * ( total\_time \_in \_a \_year )} - \\ \frac{F * R * F * R}{( total\_time \_in \_a \_year ) * ( total\_time \_in \_a \_year )} - \\ \frac{S * T}{( total\_time \_in \_a \_year )}\end{matrix} \\ \qquad ( eq . 6 )$$

The above equations 1-6 are adapted to describe the behavior of an auto switch apparatus such as described above with respect to FIG. 1. The equations utilize several conditions and relationships denoted above as F, R, S and T to prove that a desired average system uptime rate (SUR), for example, is achieved using the topology of FIG. 1.

In an alternate embodiment, a desired uptime rate is pre-selected and the above conditions and relationships are determined in a manner intended to achieve the desired uptime rate. For example, rather than predefining the number of auto-switch operations to occur within a year (condition S), the alternate embodiment determines precisely how many auto-switch operations to perform over the course of a year such that a desired system uptime rate (SUR) is achieved.

Specifically, in a system such as described in FIG. 1, the following conditions and relationships are provided in an embodiment to determine an auto switch rate (S):

F: The average number of signal conditions per line in a year.

R: The average repair time of a line signal condition once it is detected.

S: The number of auto-switch operations occurring in a year.

T: The average switch time of an auto-switch operation.

U: The system average un-available time.

Y: The total time in a year.

A: The system target uptime rate.

The system average unavailable time (U) is given by equation 7, as follows (which is based on equation 6):

U=(1−A)*Y (eq. 7)

By combining equations 5 and 7, the number of auto-switch operations occurring in a year(s) is given by equation 8, as follows:

$$S = \frac{1}{2 * T} * [ ( Y - A * Y - \frac{F * R * F * R}{Y} ) \\ \pm \sqrt{( A * Y - Y + F * R * F * R / Y ) * ( A * Y - Y + F * R * F * R / Y ) - 2 * T * F * R * F} ; \qquad ( eq . 8 )$$

It is noted that there are two solutions to equation 8. The solution providing the smaller number is utilized, since such solution requires fewer switch actions. Equation 8 will generate an un-reasonable answer to an un-achievable target uptime rate. For example, S will be a negative number if the target uptime rate is 100%.

Several examples will now be discussed. For example, assume that a transmission system has two average failures per line per year (F=2) and a three-hour average repair time (R=3 hr.) once a failure is detected.

(a) The system average uptime rate with the two-card 1+1 protection solution is determined as follows (assume that this system does an auto-switch once a day and the switch time is 5 ms (0.005 second)):

F=2, R=3 hours=10800 seconds, S=365, T=0.005 second.

Based on equation 5:

$$\begin{matrix}The system un \text{-} available time in a year = \frac{2 * 10800 * 2}{2 * 365} + \frac{2 * 10800 * 2 * 10800}{365 * 24 * 3600} + 365 * 0.005 \\ = 75.8 seconds\end{matrix} \\$$

Based on equation 6:

System uptime rate=1−75.8/(365*24*3600)=99.99976%

(b) The number of times this system shall do an auto-switch if the design goal is to get a ‘Five-Nine’ uptime rate (i.e., better than 99.999%) is determined as follows (assume that this system implements the two-card 1+1 protection solution with auto-switch and the switch time is 5 ms.)

F=2, R=3 hours=10800 seconds, S is unknown, T=0.005 second.

Based on equation 6:

The system un-available time in a year of ‘Five-Nine’ uptime rate

$$= ( 1 - 0.99999 ) * ( 365 * 24 * 3600 ) = 315.36 seconds$$

$$Based on equation 5 : \\ 315.36 = \frac{2 * 10800 * 2}{2 * S} + \frac{2 * 10800 * 2 * 10800}{365 * 24 * 3600} + S * 0.005 \\ -- -> 315.36 = 21600 / S + 14.8 + S * 0.005 \\ -- -> S * 0.005 - 300.56 + 21600 / S = 0 \\ -- -> S = ( \frac{1}{0.005 * 2} ) * ( 300.56 \pm \sqrt{300.56 * 300.56 - 4 * 0.005 * 21600} ) \\ -- -> S = 60040 or 72$$

The above equation yields two possible answers. Since from a customer's point of view, auto-switch shall do a switch as infrequently as possible, the lower answer S=72 is selected. That is, this system shall do an auto-switch once every 121.66 hours (about 5 days).

(c) The best possible system average uptime rate using the two-card 1+1 protection solution with auto-switch is determined as follows (assuming a 5 mSec switch time).

F=2, R=3 hours=10800 seconds, S is unknown, T=0.005 second.

Let the system un-available time in a year be u(S).

Based on equation 5:

u(S)=21600/S+14.8+0.005*S

First degree derivative on S:

u′(S)=0.005−21600/(S*S)

Second degree derivative on S:

u″(S)=43200/(S*S*S)

Since S>0, so u″(S)>0. There is a minimum for u(S).

Let u′(S)=0, 0.005−21600/(S*S)=0.

The minimum of u(S) is S=2078.

The system shall do an auto-switch once every 4.2 hours.

The system un-available time u(S=2078)=35.585 seconds.

Based on equation 6:

The best possible system uptime rate

=1−35.585/(365*24*3600)

=99.999887%

The above examples show that the auto-switch teachings of the invention significantly improve system uptime rates and that the two-card solution has an uptime rate that is very close to the uptime rate of the four-card solution. Based on system information and target uptime rate, a system operator can set the auto-switch time period. The major disadvantage of auto-switch is that customer traffic is interrupted during switch. However, since the inventor has determined that the cost of optical power monitor is relative low, a combination of power monitor and auto-switch will largely reduce the number of needed switch to a target uptime rate and add very little additional cost to the whole system.

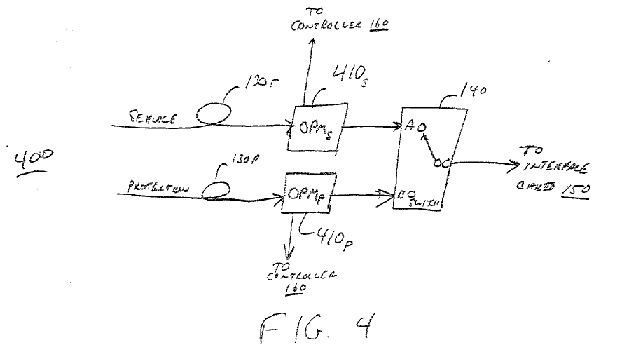

FIG. 4 depicts a high-level block diagram of a portion of the communications system of FIG. 1 modified according to an alternate embodiment of the invention. Specifically, FIG. 4 depicts the service 130S and protection 130P coupled to the switch 140 after processing by, respectively, a first optical power measuring device 410_{S} and a second optical power measuring device 410_{P}. The optical power measuring devices 410 may be constructed in the standard manner by, for example, using a splitter to divert a small portion of a signal to be measured to a power-measuring device. In this manner, the service 130S and protection 130P lines couple substantially all (e.g., 99%) of their respective optical power to the switch 140. A small amount (e.g., 1%) is used to provide a signal that is measured to determine thereby a power level of the optical channel.

The controller utilizes optical-power indicative signals provided by the optical power measuring devices to control the switch. For example, in the case of an optical power monitoring device indicating that one of the selected and non-selected lines exhibit an inappropriate optical power level, the controller causes the switch to avoid selecting the line exhibiting the inappropriate optical power level. The condition is then transmitted to service systems or personnel.

The controller also utilizes performance and error related signal provided by the interface card to control the switch. For example, in the case of the interface card indicating that the presently selected (i.e., active) line exhibits a bit error rate (BER) above a threshold level (or other inappropriate error and/or performance conditions), the controller causes the switch to deselect the active line and select the other line. The condition is then transmitted to service systems or personnel.

It will be appreciated by those skilled in the art that the various equations presented in this disclosure may be modified in numerous ways while still practicing the disclosed invention. For example, while some of the rates are discussed in terms of event per year, other periods of time (e.g., semiannual or quarterly) may be used and the equations adapted accordingly.

Although various embodiments which incorporate the teachings of the present invention have been shown and described in detail herein, those skilled in the art can readily devise many other varied embodiments that still incorporate these teachings.

What is claimed is:

1. Apparatus, comprising:
a switch for providing received data traffic from one of a service line and a protection line to an interface device; and
a controller, for causing said switch to alternately select said service and protection lines according to a switch rate selected to provide a minimum system uptime rate.

2. The apparatus of claim 1, further comprising:
at least one optical power monitoring device for determining an optical power level of at least one of said service line and said protection line; said controller, in response to a signal from said at least one optical power monitoring device, causing said switch to avoid selecting a line exhibiting an inappropriate optical power level.

3. The apparatus of claim 1, wherein:
said controller, in response to a signal said interface card, causing said switch to deselect a line exhibiting an inappropriate performance level.

4. The apparatus of claim 3, wherein said inappropriate performance level comprises a bit error rate (BER) above a threshold level.

5. The apparatus of claim 1, wherein said switch rate is determined according to the following equation:
$$S = \frac{1}{2 * T} * [ ( Y - A * Y - \frac{F * R * F * R}{Y} ) \\ \pm \sqrt{( A * Y - Y + F * R * F * R / Y ) * ( A * Y - Y + F * R * F * R / Y ) - 2 * T * F * R * F} ;$$
wherein F is the average number of signal conditions per line in a year; R is the average repair time of a line signal condition once it is detected; S is the number of auto-switch operations occurring in a year; T is the average switch time of an auto-switch operation; U is the system average un-available time; Y is the total time in a year; and A is the system target uptime rate.

6. The apparatus of claim 1, wherein said system uptime rate (SUR) is determined according to the following equation:
SUR=1−[(F*R*F)/(2*S)+(F*R*F*R)/Y+S*T]/Y
wherein F is the average number of signal conditions per line in a year; R is the average repair time of a line signal condition once it is detected; S is the number of auto-switch operations occurring in a year; T is the average switch time of an auto-switch operation; U is the system average un-available time; Y is the total time in a year.
F: The average number of signal conditions per line in a year.
R: The average repair time of a line signal condition once it is detected.
S: The number of auto-switch operations occurring in a year.
T: The average switch time of an auto-switch operation.

7. A system, comprising:
a switch, for routing received data traffic from one of a service line and a protection line to an interface device according to a determined switching rate, said switching rate determined in accordance with a desired system uptime rate.

8. The system of claim 7, wherein said switch rate is determined according to the following equation:
$$S = \frac{1}{2 * T} * [ ( Y - A * Y - \frac{F * R * F * R}{Y} ) \\ \pm \sqrt{( A * Y - Y + F * R * F * R / Y ) * ( A * Y - Y + F * R * F * R / Y ) - 2 * T * F * R * F} ;$$
wherein F is the average number of signal conditions per line in a year; R is the average repair time of a line signal condition once it is detected; S is the number of auto-switch operations occurring in a year; T is the average switch time of an auto-switch operation; U is the system average un-available time; Y is the total time in a year; and A is the system target uptime rate.

9. The system of claim 7, further comprising:
a first optical power measurement apparatus for measuring the optical power of said service line, and a second optical power measurement apparatus for measuring the optical power of said protection line, said first and second optical power measurement apparatus providing output signals indicative of

10. The system of claim 7, further comprising:
an optical splitter, for splitting optical data traffic provided by a second interface device into a first data stream for transmission to said switch via said service line a second data stream for transmission to said switch via said protection line.

11. In a system comprising a switch for providing received data traffic from one of a service line and a protection line to a single interface device, a method for providing a desired system uptime rate, comprising:
causing said switch to alternately select said service and protection lines according to a switch rate selected to provide said desired system uptime rate.

12. The method of claim 11, further comprising:
determining an optical power level of at least one of said service line and said protection line; and
causing said switch to avoid selecting a line exhibiting an inappropriate optical power level.

13. The method of claim 12, wherein said inappropriate optical power level is determined by an optical power monitoring device associated with a said inactive line.

14. The method of claim 11, further comprising:
determining a quality of service (QoS) performance level of a selected one of said service line and protection line; and
causing said switch to deselect a line exhibiting an inappropriate performance level.

15. The method apparatus of claim 14, wherein said inappropriate performance level comprises a bit error rate (BER) above a threshold level.

16. The method of claim 11, further comprising:
causing said switch to alternately select said service and protection lines according to a switch rate (S) determined according to the following equation:
$$S = \frac{1}{2 * T} * [ ( Y - A * Y - \frac{F * R * F * R}{Y} ) \\ \pm \sqrt{( A * Y - Y + F * R * F * R / Y ) * ( A * Y - Y + F * R * F * R / Y ) - 2 * T * F * R * F} ;$$
wherein F is the average number of signal conditions per line in a year; R is the average repair time of a line signal condition once it is detected; S is the number of auto-switch operations occurring in a year; T is the average switch time of an auto-switch operation; U is the system average un-available time; Y is the total time in a year; and A is the system target uptime rate.

17. In a system comprising a switch for providing received data traffic from one of a service line and a protection line to a single interface device, a method for providing a desired system uptime rate, comprising:
causing said switch to alternately select said service and protection lines according to a switch rate (S) adapted to provide said desired system uptime rate according to the following equation:
SUR=1−[(F*R*F)/(2*S)+(F*R*F*R)/Y+S*T]/Y
wherein F is the average number of signal conditions per line in a year; R is the average repair time of a line signal condition once it is detected; S is the number of auto-switch operations occurring in a year; T is the average switch time of an auto-switch operation; U is the system average un-available time; Y is the total time in a year.
